(19) United States
(12) Patent Application Publication
(10) Pub. No.: US 2023/0342178 A1
(43) Pub. Date: Oct. 26, 2023

(54) MANAGING VIRTUAL INFRASTRUCTURE WITH SELF-INITIALIZED UPGRADES

(71) Applicant: VMWARE, INC., Palo Alto, CA (US)

(72) Inventors: TOMO VLADIMIROV SIMEONOV, Sofia (BG); IVAYLO RADOSLAVOV RADEV, Sofia (BG); SANDEEP SINHA, Bangalore (IN); PRADEEP JIGALUR, Bangalore (IN)

(21) Appl. No.: 17/832,716

(22) Filed: Jun. 6, 2022

(30) Foreign Application Priority Data
Apr. 22, 2022 (IN) 202241023828

(51) Int. Cl. G06F 9/455; G06F 9/445

(52) U.S. Cl. CPC G06F 9/45558; G06F 9/44505; G06F 2009/4557; G06F 2009/45587

(57) ABSTRACT

Managing virtual infrastructure with self-initialized upgrades, such as upgrades or configuration changes, includes receiving, by a first virtual machine (VM) that provides a management function for a plurality of VMs, an indication of a pending configuration change. The first VM identifies, from within the plurality of VMs, a VM having a property which is associated with the first VM. This enables the first VM to locate itself among the plurality of VMs that it manages. Based on at least locating itself among the plurality of managed VMs (e.g., determining that the first VM comprises the identified VM), the first VM performs the configuration change on itself. Example changes include increasing memory, increasing storage allocation, increasing the number of processors, and other changes that may be associated with upgrading or migrating a VM.

### RELATED APPLICATIONS

Benefit is claimed under 35 U.S.C. 119(a)-(d) to Foreign Application Serial No. 202241023828 filed in India entitled “MANAGING VIRTUAL INFRASTRUCTURE WITH SELF-INITIALIZED UPGRADES”, on Apr. 22, 2022, by VMware, Inc., which is herein incorporated in its entirety by reference for all purposes.

### BACKGROUND

A virtual machine (VM) functions in a virtual environment (e.g., virtual infrastructure) as a virtual computer system with its computing resources (e.g., processor, memory, network interface, and storage) allocated from a physical hardware system. In many operational scenarios, the resource demands placed by large VMs on the underlying computational platform may become excessive. Thus, VMs are generally configured with computing resources commensurate to the expected task. However, when new services are added to a VM, the VM may require additional resources, such as more memory, additional processor cores, and larger storage.

Unfortunately, resizing VMs (e.g., increasing memory, storage, or processor count) is challenging, due to complexity and the likelihood of human error during the process. When the number of VMs is too large to resize in a timely manner (e.g., thousands or more VMs), the work-around may be to move the jobs, being executed by the VMs, to a different set of VMs that already have the needed resources. However, this work-around is disruptive. Additionally, even if the number of VMs is sufficiently low for a human to resize manually, if the need for a VM upgrade is not identified in sufficient time to complete the upgrade prior to a crash caused by resource constraint (e.g., low memory or insufficient storage), computing operations may be severely impacted.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for managing virtual infrastructure with self-initialized upgrades that include: receiving, by a first virtual machine (VM) that provides management function for a plurality of VMs, an indication of a pending configuration change; identifying, by the first VM, from within the plurality of VMs, a VM having a property, wherein the property is associated with the first VM; based on at least identifying the VM having the property, determining, by the first VM, that the first VM comprises the identified VM; and based on at least determining that the first VM comprises the identified VM, performing, by the first VM, the configuration change on the first VM.

### BRIEF DESCRIPTION OF THE DRAWINGS

The present description will be better understood from the following detailed description read in the light of the accompanying drawings, wherein:

FIG. 1 illustrates an architecture that may advantageously manage virtual infrastructure with self-initialized upgrades;

FIG. 2 illustrates further detail for some examples of the architecture of FIG. 1;

FIG. 3 illustrates a message sequence diagram associated with examples of the architecture of FIG. 1;

FIG. 4 illustrates another message sequence diagram associated with examples of the architecture of FIG. 1;

FIG. 5 illustrates a flowchart of exemplary operations associated with examples of the architecture of FIG. 1;

FIG. 6 illustrates another flowchart of exemplary operations associated with examples of the architecture of FIG. 1; and

FIG. 7 illustrates a block diagram of a computing apparatus that may be used as a component of the architecture of FIG. 1, according to an example.

### DETAILED DESCRIPTION

Aspects of the disclosure manage a virtual infrastructure with self-initialized upgrades. For example, the disclosure provides for automatic resizing of a self-managing virtual infrastructure without any human interaction. The process includes receiving, by a first virtual machine (VM) that provides a management function for a plurality of VMs, an indication of a pending configuration change. The first VM identifies, from within the plurality of VMs, a VM having a property associated with the first VM. This enables the first VM to locate itself among the plurality of VMs that it manages. Based on at least locating itself among the plurality of managed VMs (e.g., determining that the first VM comprises the identified VM), the first VM performs the configuration change on itself. Example changes include increasing memory, increasing storage allocation, increasing the number of processors, and other changes that may be associated with upgrading or migrating a VM.

Aspects of the disclosure improve the functioning of physical computing devices at least by managing the computing resources (e.g., storage, memory, processing, and more) of those physical devices (including prevent device crashes). Further aspects of the disclosure improve the technical performance (e.g., improve speed and reliability) of computing operations that use VMs. These advantages are accomplished, at least in part, by a VM locating itself among a plurality of VMs for which it provides a management function without human interaction or additional information provided. For example, the VM identifies a VM (within the plurality of VMs) having a predetermined unique property that is associated with that VM (e.g., associated with itself).

Such a capability has utility and practical value, such as when the sheer number of VMs is beyond the capability of management by humans, and/or the time interval between identifying the need for an upgrade and a looming crash (e.g. caused by a resource constraint of the VM) is insufficient to permit a human to manage the upgrade. With this capability, VMs may be configured, from a computing resource standpoint, commensurately with the expected task, thereby limiting the burden on the underlying computational platform. But when the computational requirements of the VMs grows beyond that for which the VMs were initially configured, the VMs may be rapidly upgraded before a crash occurs (e.g., without human involvement). The need to involve human management is precluded.

This new capability provides measureable benefits. For example, a larger number of smaller VMs may be initially provisioned, thereby making more efficient use of the underlying computational resources of the physical hardware (e.g., a smaller platform and/or more VMs on the same platform, providing cost savings), while permitting sufficiently rapid upgrade(s) when needed to reduce the risk of a resource-induced crash (thus providing higher reliability). The functioning of the underlying device is improved at least because crashes are avoided and reliability is increased.

However, self-initialized VM upgrades are complex. A VM within a virtual environment does not have a basis for a reference external to the VM. Much of the identifying information, such as an internet protocol (IP) address, a media access control (MAC) address, a host name, and other properties and/or identifiers may be duplicated, removing the ability of the VM to identify itself. Management of a VM by itself cannot occur reliably if the VM cannot distinguish itself from other VMs. If the VM reconfigures the incorrect VM, not only will this waste resources on a VM that does not require upgrade, but the VM that needs an upgrade will not receive the upgrade. The disclosure provides for a self-initialized VM upgrade that does not involve human management. For example, the disclosure includes a predetermined unique property (unique among the VMs) that enables the VM to reliably identify whether it has located itself from among multiple (a plurality of) other VMs. For at least these reasons, the disclosure goes beyond merely automating a previously manual process.

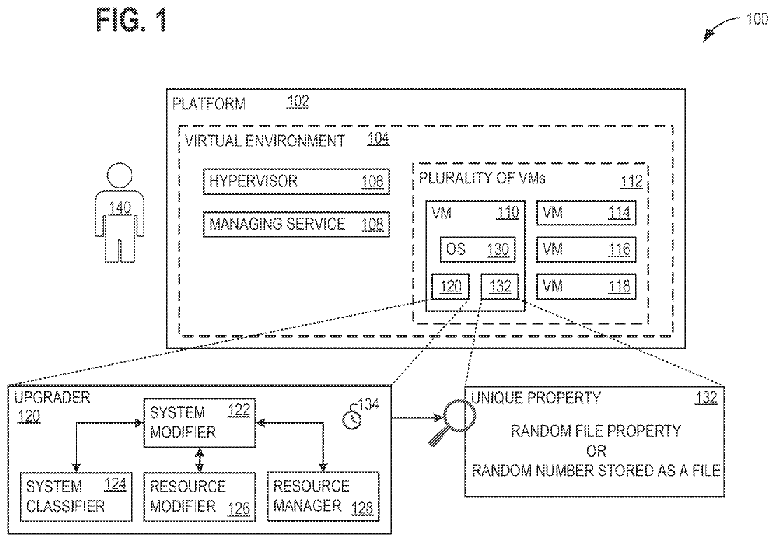

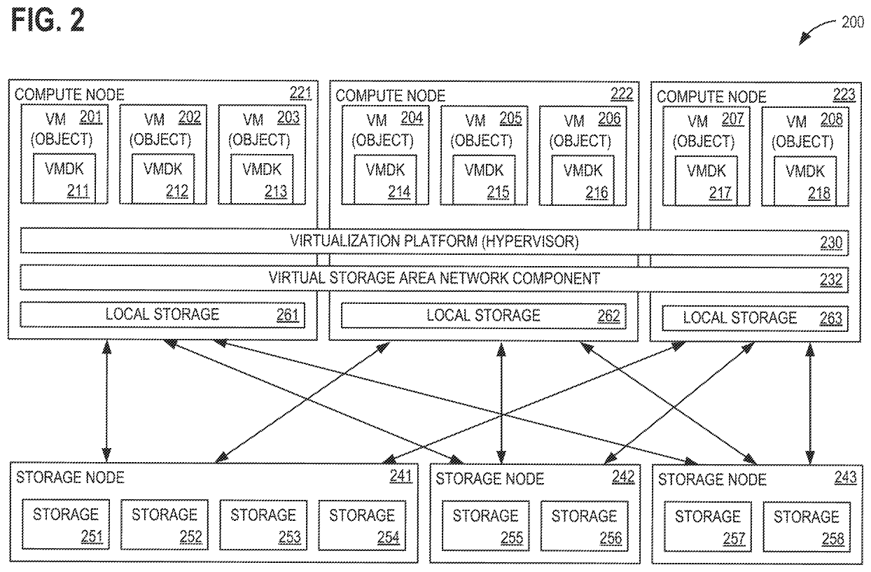

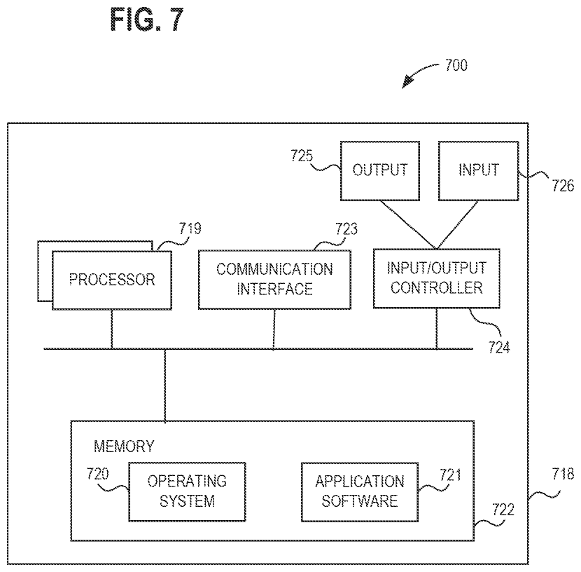

FIG. 1 illustrates an architecture 100 that may advantageously manage virtual infrastructure with self-initialized upgrades. In some examples, architecture 100 includes a computing platform 102 which may be implemented on one or more computing apparatus 718 of FIG. 7, and/or using a virtualization architecture 200, as illustrated in FIG. 2. In some examples, may operate within a software-defined data center (SDDC). Computing platform 102 provides a virtual infrastructure 104 for a plurality of VMs 112 under the control of a hypervisor 106. Hypervisor 106 may be provided as part of virtualization platform 230, which is described in further detail in relation to FIG. 2.

In some examples, hypervisor 106 may comprise an enterprise-class, type-1 hypervisor, such as ESXi, or may comprise a type-2 hypervisor, in which case computing platform 102 would also require a separate operating system (OS). A managing service 108 is also provided for virtual infrastructure 104. Managing service 108 stores information regarding all VMs within virtual infrastructure 104, and is located, in some examples, within the VM that is managing plurality of VMs 112. Managing service 108 communicates with the host and provides centralized management functionality such as move, rename, reconfigure, resize, stop, power-on, and destroy the managed VMs.

Plurality of VMs 112 includes a VM 110, a VM 114, a VM 116, and a VM 118. Although only four VMs are illustrated, it should be understood that, in some examples, plurality of VMs 112 may have thousands to millions of VMs, rendering management by a human user 140 both impractical and undesirable. In architecture 100, each VM of plurality of VMs 112 may advantageously be initially configured to use only just the amount of resources (e.g., memory, processors, storage) as needed for the expected task. When the number of VMs is large, this configuration may provide significant cost savings. The need to configure each VM of plurality of VMs 112 to use as many resources as is necessary for the worst-case imaginable computational burden is precluded (thereby potentially overly-burdening computing platform 102), because when an increased computational burden is expected, the VMs may be reconfigured as needed.

VM 110 manages the VMs of plurality of VMs 112, including itself, and the VMs comprise objects such as objects 201-208 that are described in relation to FIG. 2. In some examples, VM 110 and VMs 114-118 (the VMs of plurality of VMs 112) are manifest as VM disk files (VMDKs). In some examples, VM 110 comprises server management software, such as vCenter, that provides a centralized platform for controlling virtual environments such as virtual infrastructure 104. VM 110 has an OS 130, which in some examples, is a Linux OS. When VM 110 is deployed on the infrastructure it manages (e.g., virtual infrastructure 104) it is a self-managed VM and is able to manage itself (including upgrading itself) along with managing (and upgrading) the other VMs it manages, such as VMs 114-118.

A self-managed VM is able to use its own application programming interfaces (APIs) to extend its own configuration (e.g., increase memory, processor count, storage size, add network adapters, add floppy and optical drives), move to a different host, and reduce its configuration (e.g., reduce storage size, remove network adapters, remove floppy and optical drives)—without the need for user 140 to manually perform the changes. Whereas user 140 would typically need to input a user identity and login credentials to establish permissions, a self-managed VM (e.g., VM 110) is able to make such changes without inputting a user identity or login credentials. This is because VM 110 is making such changes from within the zone of trust in which VM 110 is operating.

VM 110 is able to identify that it is managing itself, despite the potential duplication of many identifying properties and lacking an external reference, via a unique property 132. In some examples, unique property 132 is a file property of the VMDK of VM 110, or is a random number stored as a file in VM 110 (e.g., the name of the file stored within VM 110 and/or the contents of the file). An upgrader 120 searches for unique property 132 as a predetermined element, and when upgrader 120 searches for unique property 132, this indicates that VM 110 has found itself among the VMs that VM 110 manages.

In order to ensure the presence of unique property 132 prior to upgrader 120 searching, VM 110 generates a random value, which may include purely numerical values and/or other characters (e.g., hexadecimal, alphanumeric). The random value may be generated using a random number generator, or may be a hash value of available information (e.g., a timestamp of when VM 110 generates unique property 132 concatenated with additional semi-unique information). Later, when upgrader 120 begins searching, unique property 132 is a predetermined unique property.

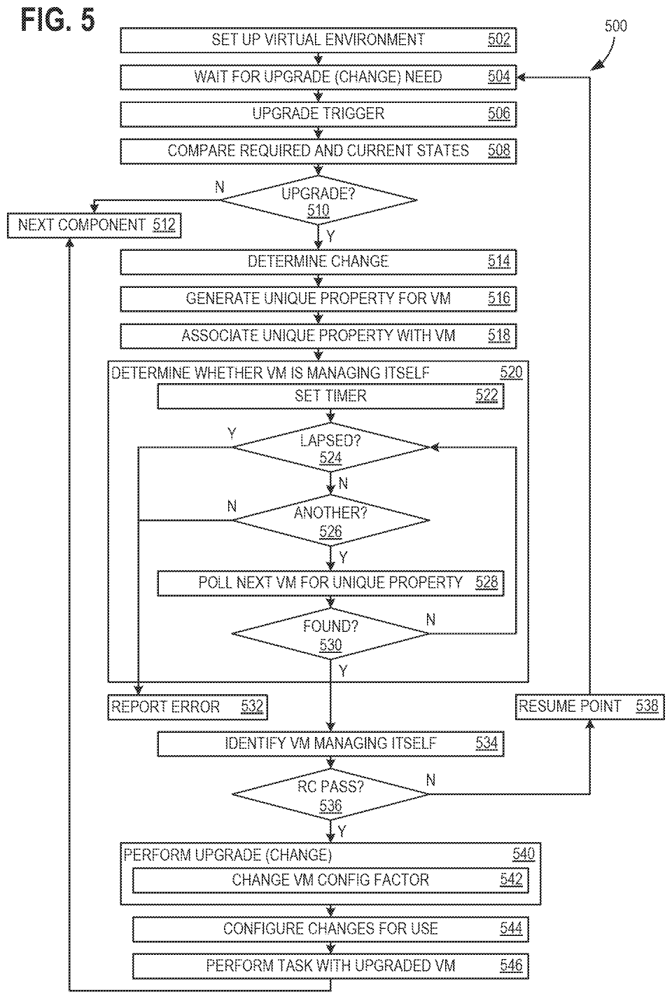

Upgrader 120 is illustrated as comprising four components: a system modifier 122, a system classifier 124, a resource modifier 126, and a resource manager 128, although it should be understood that the functionality described herein for upgrader 120 may be provided by a myriad of different configurations. In the described example, system modifier 122 manages system level modification of VM 110; system classifier 124 detects deployment type, identifies required changes to VM 110 (e.g., performs operation 514 of FIG. 5), and reports this information to other components of upgrader 120; resource modifier 126 add the required resources or removes resources as specified (e.g., performs operation 540 of FIG. 5); and resource manager 128 performs system-side changes, such as mounting and/or formatting disks, so that added resources are usable (e.g., performs operation 544 of FIG. 5).

Examples of architecture 100 are operable with virtualized solutions. FIG. 2 illustrates a virtualization architecture 200 that provides a virtual infrastructure for architecture 100, for example by providing a version of computing platform 102. Virtualization architecture 200 is comprised of a set of compute nodes 221-223, interconnected with each other and a set of storage nodes 241-243 according to an embodiment. In other examples, a different number of compute nodes and storage nodes may be used. Each compute node hosts multiple objects, which may be VMs, such as base objects, linked clones, independent clones, containers, applications, or any compute entity (e.g., computing instance or virtualized computing instance) that consumes storage. When objects are created, they may be designated as global or local, and the designation is stored in an attribute. For example, compute node 221 hosts objects 201, 202, and 203; compute node 222 hosts objects 204, 205, and 206; and compute node 223 hosts objects 207 and 208. Some of objects 201-208 may be local objects. In some examples, a single compute node may host 50, 100, or a different number of objects. Each object uses a VMDK, for example VMDKs 211-218 for each of objects 201-208, respectively. Other implementations using different formats are also possible. A virtualization platform 230, which includes hypervisor functionality at one or more of computer nodes 221, 222, and 223, manages objects 201-208. In some examples, various components of virtualization architecture 200, for example compute nodes 221, 222, and 223, and storage nodes 241, 242, and 243 are implemented using one or more computing apparatus such as computing apparatus 718 of FIG. 7.

Virtualization software that provides software-defined storage (SDS), by pooling storage nodes across a cluster, creates a distributed, shared data store, for example a storage area network (SAN). Thus, objects 201-208 may be virtual SAN (vSAN) objects. In some distributed arrangements, servers are distinguished as compute nodes (e.g., compute nodes 221, 222, and 223) and storage nodes (e.g., storage nodes 241, 242, and 243). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 241-243 each include multiple physical storage components, which may include flash, SSD, NVMe, PMEM, and QLC storage solutions. For example, storage node 241 has storage 251, 252, 252, and 254; storage node 242 has storage 255 and 256; and storage node 243 has storage 257 and 258. In some examples, a single storage node may include a different number of physical storage components.

In the described examples, storage nodes 241-243 are treated as a SAN with a single global object, enabling any of objects 201-208 to write to and read from any of storage 251-258 using a virtual SAN component 232. Virtual SAN component 232 executes in compute nodes 221-223. Using the disclosure, compute nodes 221-223 are able to operate with a wide range of storage options. In some examples, compute nodes 221-223 each include a manifestation of virtualization platform 230 and virtual SAN component 232. Virtualization platform 230 manages the generating, operations, and clean-up of objects 201 and 202. Virtual SAN component 232 permits objects 201 and 202 to write incoming data from object 201 and incoming data from object 202 to storage nodes 241, 242, and/or 243, in part, by virtualizing the physical storage components of the storage nodes.

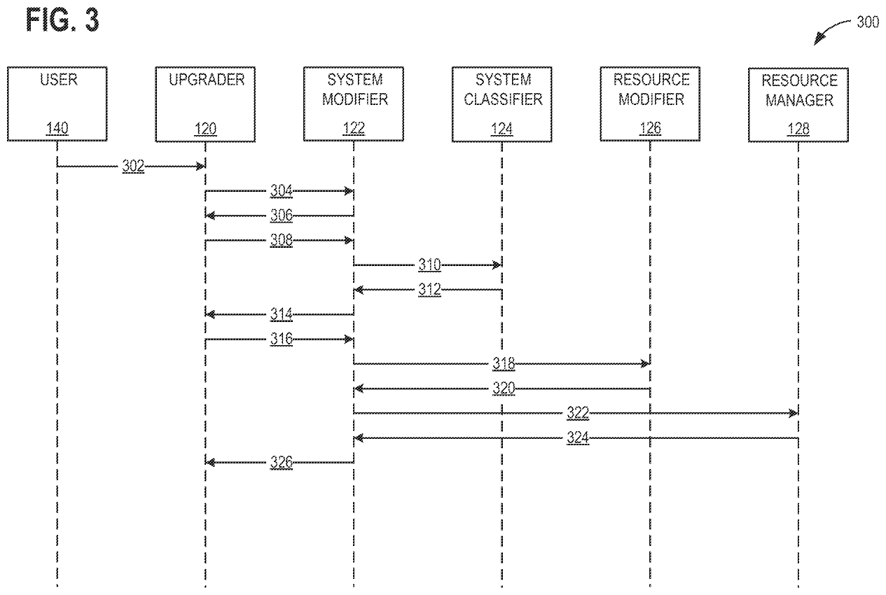

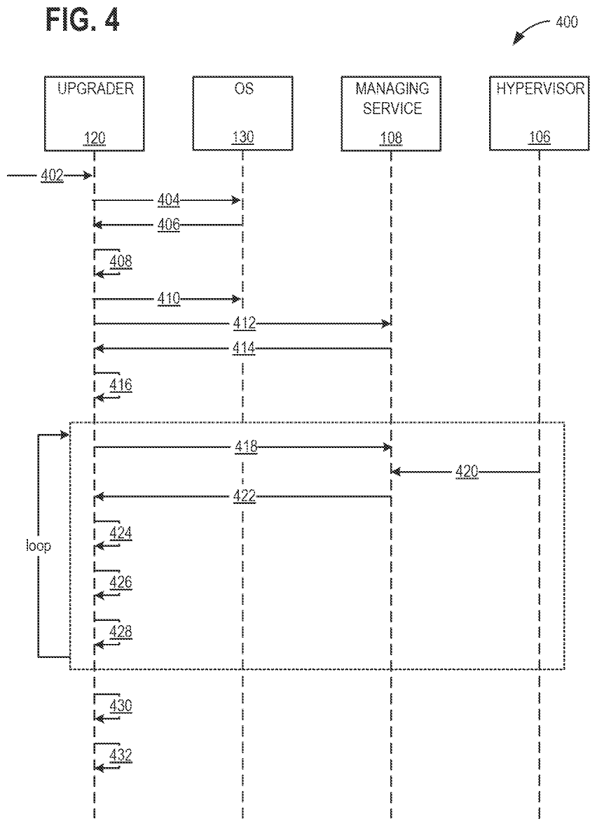

FIG. 3 illustrates a message sequence diagram 300 associated with some examples of architecture 100. User 140 (or a process acting as a user) initiates the process with message 302 to upgrader 120 that triggers a need for an upgrade or other configuration change of at least VM 110. In some examples, VM 110 will need to be expanded by adding resources, whereas in some examples, VM 110 may be curtailed by removing individual resources. Some examples contemplate both additional and removal of resources, such as increasing memory and reducing storage size. The remainder of message sequence diagram 300 continues after VM 110 has identified that it is managing itself, using messages shown in message sequence diagram 400 of FIG. 4 (described below) and described in further detail in relation to FIG. 5.

Referring to message sequence diagram 300, upgrader 120 initiates a discovery process with message 304 to system modifier 122, which returns component dependencies in message 306. Upgrader 120 sends requirements to system modifier 122 with message 308, which sends a specification of changes required to system classifier 124 in message 310. System classifier 124 responds to system modifier 122 with host detail questions in message 312, which are passed back to updater 120 as message 314.

Upgrader 120 sends a system prepare message 316 to system modifier 122, which generates a configuration change instruction and sends it to resource modifier 126 in message 318. Upon completing the configuration changes, resource modifier 126 returns a success message 320 to system modifier 122. System modifier 122 then instructs resource manager 128 to configure the added resources with message 322. Upon completion, system modifier 122 returns a success message 324 to system modifier 122, which then reports success to upgrader 120 in message 326.

FIG. 4 illustrates message sequence diagram 400 that shows an example set of messages used by VM 110 to identify that VM 110 is managing itself. Upgrader 120 receives a message 402 indicating a desired state for VM 110 and polls OS 130 regarding the configuration of VM 110 (e.g., amount of memory, processor count, storage size, disks, adapters, other) with message 404. OS 130 responds with the information in message 406. Upgrader 120 determines the difference between the current state of VM 110 and the required state of VM 110, which enables determining the configuration change needed (see operation 514 of FIG. 5). This is shown as message 408. Upgrader 120 sets unique property 132 using a message 41 to OS 130, and requests a list of all VMs in plurality of VMs 112 from managing service 108 using message 412. Managing service 108 provides the list to upgrader 120 using message 414.

Upgrader 120 sets a timer 134 at 416 (see also operation 522 of FIG. 5) and then loops through messages 418-428 until one of three conditions is satisfied: (1) a VM within plurality of VMs 112 is found that is associated with unique property 132 (e.g., VM 110 has found itself), (2) timer 134 expires, or (3) VM 110 has checked each VM within plurality of VMs 112 and none is associated with unique property 132 (e.g., VM 110 is not within the set of VMS that VM 110 manages). While timer 134 is running, upgrader 120 loops through the list of VMs within plurality of VMs 112 and queries managing service 108 each VM, with message 418. Hypervisor updates managing service 108 regarding the VMs using message 420, as needed. Managing service 108 responds to upgrader 120 with message 422. Some examples do not use timer 134, and instead check all VMs without a risk of a time-out.

At 424, upgrader 120 validates the response in message 422 from managing service 108. At 426, upgrader 120 determines whether the response includes unique property 132 (see also operation 530 of FIG. 5). If not, upgrader 120 determines whether timer 134 has lapsed, at 428. If unique property 132 has been found, upgrader 120 performs the configuration change at 430, or otherwise returns an error condition indicating timeout or VM 110 is not managing itself at 432.

FIG. 5 illustrates a flowchart 500 of exemplary operations associated with architecture 100, and described thus far in reference to FIGS. 3 and 4. In some examples, the operations of flowchart 500 are performed by one or more computing apparatus 718 of FIG. 7. Flowchart 500 commences with operation 502, in which virtual infrastructure 104 is set up with plurality of VMs 112, including VM 110. Virtual infrastructure 104 waits for an upgrade trigger at 504, which is received at 506 (e.g., resulting from message 302 of FIG. 3). That is, operation 506 includes receiving, by VM 110, that provides a management function for plurality of VMs 112, an indication of a pending configuration change. In some examples, each VM of plurality of VMs 112 (including VM 110) is stored as a VMDK.

In operation 508, upgrader 120 determines the required state of VM 110, determines the current state of VM 110, and compares the current state of VM 110 with the required state of VM 110. In some examples, operation 514, described below, is performed as part of operation 508. Decision operation 510 determines whether an upgrade or other changes (such as curtailing VM 110) is needed. If not, flowchart 500 moves on to managing the next component in operation 512.

If an upgrade (change) is needed, operation 514 determines the configuration change as a difference between the current state of VM 110 and the required state of VM 110. In some examples, system classifier 124 performs operation 514. In some examples, operation 514 is performed at a different time, such as part of operation 508 (earlier) or as part of operation 534 (later).

Operation 516 generates unique property 132 for VM 110. In some examples, unique property 132 does not comprise an address (e.g., IP or MAC) or a name of VM 110. In some examples, unique property 132 comprises a file property, other than a file name, of a file comprising VM 110. In some examples, the file comprising VM 110 comprises a VMDK. In some examples, unique property 132 comprises a multi-character random sequence. In some examples, the random sequence comprises a random value, such as a hash value. In some examples, unique property 132 comprises a file stored in VM 110. In some examples, unique property 132 comprises a file property of VM 110. Operation 518 then associates unique property 132 with VM 110.

Operation 520 determines whether VM 110 is managing itself, and is carried out using operations 522 through 530. Operation 522 sets a timer, and then operations 524 through 530 are looped through for each VM in plurality of VMs 112, unless timer 134 lapses first. Decision operation 524 determines whether timer 134 has lapsed (see also message 428 of FIG. 4). If so, flowchart 500 exits to operation 532 and an error condition is reported indicating that VM 110 has not been found within the allotted time. In some examples, timer 134 is set to one minute, or a similar time value.

If timer 134 has not yet lapsed, decision operation 526 determines whether there is another VM in plurality of VMs 112 to check. If not, flowchart 500 exits to operation 532. However, if there is another VM to check, and timer 134 has not yet lapsed, operation 528 polls the next VM in line for the predetermined unique property. Decision operation 530 determines whether the returned result matches unique property 132. If not, flowchart returns to operation 524. Otherwise, if a match is found, flowchart 500 exits operation 520 and moves to operation 534.

If a match is found, this means that, in operation 520, VM 110 identified, from within plurality of VMs 112, a VM having the predetermined unique property (e.g., unique property 132) that is associated with VM 110. Based on at least identifying the VM having unique property 132, operation 534 determines that VM 110 comprises the identified VM. In some examples, operation 514 is performed here, as a part of operation 534.

Decision operation 536 determines whether the requested resource creation for VM 110 will be successful (e.g., whether virtual infrastructure 104 has sufficient capacity). If not, operation 538 creates a resume point and flowchart returns to operation 504. Otherwise, if virtual infrastructure 104 has sufficient capacity, operation 540 performs the configuration change. That is operation 540 includes, based on at least determining that VM 110 comprises the identified VM, performing, by VM 110, the configuration change on VM 110. In some examples, performing the configuration change is based at least on receiving the indication of the pending configuration change by VM 110 and without receiving user login credentials by VM 110. In some examples, performing the configuration change is based at least on receiving the indication of the pending configuration change by VM 110 and without receiving a user identity by VM 110.

In some examples, resource modifier 126 performs operation 540, possibly using system scripts, and includes operation 542. In some examples, operation 542 changes at least one VM configuration factor selected from the list consisting of: memory amount, storage size, and processor count. In some examples, the processor comprises a CPU. In some examples, the configuration change increases memory amount, storage amount, and/or processor count. In some examples, the configuration change decreases storage amount. In some examples, the configuration change alters memory type, storage type, and/or processor type. In some examples, the configuration change adds or removes a network adapter, or migrates VM 110 to a new host. Upon completion, a success message may be generated. See messages 318 and 320 of FIG. 3.

Operation 544 configures the changes for use by VM 110, which in some examples, is performed by resource manager 128. Upon completion, a success message is generated. See messages 322 and 324 of FIG. 3. Operation 546 uses the upgraded version of VM 110 to perform a computational task. Flowchart 500 then moves to operation 512.

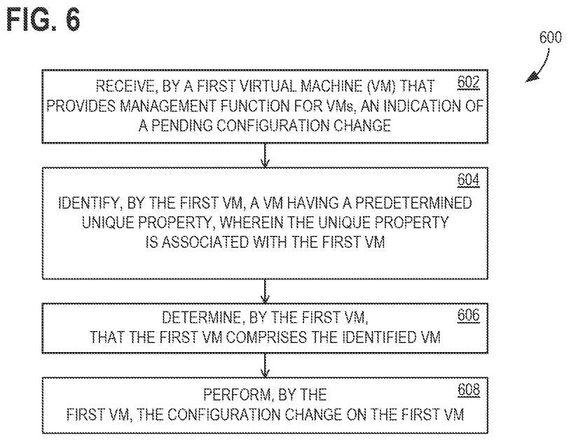

FIG. 6 illustrates a flowchart 600 of exemplary operations associated with architecture 100. In some examples, the operations of flowchart 600 are performed by one or more computing apparatus 718 of FIG. 7. Flowchart 600 commences with operation 602, which includes receiving, by a first VM that provides a management function for a plurality of VMs, an indication of a pending configuration change. Operation 604 includes identifying, by the first VM, from within the plurality of VMs, a VM having a predetermined unique property, wherein the unique property is associated with the first VM. Operation 606 includes, based on at least identifying the VM having the unique property, determining, by the first VM, that the first VM comprises the identified VM. Operation 608 includes, based on at least determining that the first VM comprises the identified VM, performing, by the first VM, the configuration change on the first VM.

### ADDITIONAL EXAMPLES

An example computer-implemented method comprises: receiving, by a first VM that provides a management function for a plurality of VMs, an indication of a pending configuration change; identifying, by the first VM, from within the plurality of VMs, a VM having a predetermined unique property, wherein the unique property is associated with the first VM; based on at least identifying the VM having the unique property, determining, by the first VM, that the first VM comprises the identified VM; and based on at least determining that the first VM comprises the identified VM, performing, by the first VM, the configuration change on the first VM.

An example computer system comprises: a processor; and a non-transitory computer readable medium having stored thereon program code executable by the processor, the program code causing the processor to: receive, by a first VM that provides a management function for a plurality of VMs, an indication of a pending configuration change; identify, by the first VM, from within the plurality of VMs, a VM having a predetermined unique property, wherein the unique property is associated with the first VM; based on at least identifying the VM having the unique property, determine, by the first VM, that the first VM comprises the identified VM; and based on at least determining that the first VM comprises the identified VM, perform, by the first VM, the configuration change on the first VM.

An example non-transitory computer storage medium has stored thereon program code executable by a processor, the program code embodying a method comprising: receiving, by a first VM that provides a management function for a plurality of VMs, an indication of a pending configuration change; identifying, by the first VM, from within the plurality of VMs, a VM having a predetermined unique property, wherein the unique property is associated with the first VM; based on at least identifying the VM having the unique property, determining, by the first VM, that the first VM comprises the identified VM; and based on at least determining that the first VM comprises the identified VM, performing, by the first VM, the configuration change on the first VM.

Alternatively, or in addition to the other examples described herein, examples include any combination of the following:
generating the unique property for the first VM;
the unique property does not comprise an address or a name of the first VM;
associating the unique property with the first VM;
performing the configuration change comprises changing at least one VM configuration factor selected from the list consisting of: memory amount, storage size, and processor count;
performing the configuration change comprises increasing memory amount, storage amount, or processor count;
performing the configuration change comprises performing the configuration change based at least on receiving the indication of the pending configuration change by the first VM and without receiving user login credentials by the first VM;
the unique property comprises a file property, other than a file name, of a file comprising the first VM;
the unique property comprises a multi-character random sequence;
determining a current state of the first VM;
determining the configuration change as a difference between the current state of the first VM and a required state of the first VM;
the file comprising the first VM comprises a VMDK;
each of the plurality of VMs is stored as a VMDK;
the first VM is stored as a VMDK;
the random sequence comprises a random value;
the random sequence comprises a hash value;
the unique property comprises a file stored in the first VM;
the unique property comprises a file property of the first VM;
performing the configuration change comprises decreasing memory amount, storage amount, or processor count;
performing the configuration change comprises changing at least one VM configuration factor selected from the list consisting of: memory type, storage type, and processor type;
performing the configuration change comprises adding a network adapter;
performing the configuration change comprises migrating the first VM to a new host;
performing the configuration change comprises migrating the plurality of VMs to a new host;
the processor comprises a CPU; and
performing the configuration change comprises performing the configuration change based at least on receiving the indication of the pending configuration change by the first VM and without receiving a user identity by the first VM.

### EXEMPLARY OPERATING ENVIRONMENT

The present disclosure is operable with a computing device (computing apparatus) according to an embodiment shown as a functional block diagram 700 in FIG. 7. In an embodiment, components of a computing apparatus 718 may be implemented as part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. Platform software comprising an operating system 720 or any other suitable platform software may be provided on the computing apparatus 718 to enable application software 721 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 718. Computer-readable media may include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission (e.g., non-transitory) medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that the storage may be distributed or located remotely and accessed via a network or other communication link (e.g. using a communication interface 723). Computer storage media are tangible, non-transitory, and are mutually exclusive to communication media.

The computing apparatus 718 may comprise an input/output controller 724 configured to output information to one or more output devices 725, for example a display or a speaker, which may be separate from or integral to the electronic device. The input/output controller 724 may also be configured to receive and process an input from one or more input devices 726, for example, a keyboard, a microphone, or a touchpad. In one embodiment, the output device 725 may also act as the input device. An example of such a device may be a touch sensitive display. The input/output controller 724 may also output data to devices other than the output device, e.g. a locally connected printing device. In some embodiments, a user may provide input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer-implemented method comprising:
receiving, by a first virtual machine (VM) that provides a management function for a plurality of VMs, an indication of a pending configuration change;
identifying, by the first VM, from within the plurality of VMs, a VM having a property associated with the first VM;
based on at least identifying the VM having the property, determining, by the first VM, that the first VM comprises the identified VM; and
based on at least determining that the first VM comprises the identified VM, performing, by the first VM, the configuration change on the first VM.

2. The method of claim 1, further comprising:
generating the property for the first VM, wherein the property does not comprise an address or a name of the first VM; and
associating the property with the first VM.

3. The method of claim 1, wherein performing the configuration change comprises changing at least one VM configuration factor selected from the list consisting of:
memory amount, storage size, processor count, a drive, and a network adapter.

4. The method of claim 3, wherein performing the configuration change comprises increasing memory amount, storage amount, processor count, drives, or network adapters.

5. The method of claim 1, wherein performing the configuration change comprises performing the configuration change based at least on receiving the indication of the pending configuration change by the first VM and without receiving user login credentials by the first VM.

6. The method of claim 1, wherein the property comprises a file property, other than a file name, of a file comprising the first VM.

7. The method of claim 1, further comprising:
determining a current state of the first VM; and
determining the configuration change as a difference between the current state of the first VM and a required state of the first VM.

8. A computer system comprising:
a processor; and
a non-transitory computer readable medium having stored thereon program code executable by the processor, the program code causing the processor to:
receive, by a first virtual machine (VM) that provides a management function for a plurality of VMs, an indication of a pending configuration change;
identify, by the first VM, from within the plurality of VMs, a VM having a property associated with the first VM;
based on at least identifying the VM having the property, determine, by the first VM, that the first VM comprises the identified VM; and
based on at least determining that the first VM comprises the identified VM, perform, by the first VM, the configuration change on the first VM.

9. The computer system of claim 8, wherein the program code is further operative to:
generate the property for the first VM, wherein the property does not comprise an address or a name of the first VM; and
associate the property with the first VM.

10. The computer system of claim 8, wherein performing the configuration change comprises changing at least one VM configuration factor selected from the list consisting of:
memory amount, storage size, processor count, a drive, and a network adapter.

11. The computer system of claim 10, wherein performing the configuration change comprises increasing memory amount, storage amount, processor count, drives, or network adapters.

12. The computer system of claim 8, wherein performing the configuration change comprises performing the configuration change based at least on receiving the indication of the pending configuration change by the first VM and without receiving user login credentials by the first VM.

13. The computer system of claim 8, wherein the property comprises a file property, other than a file name, of a file comprising the first VM.

14. The computer system of claim 8, wherein the program code is further operative to:
determine a current state of the first VM; and
determine the configuration change as a difference between the current state of the first VM and a required state of the first VM.

15. A non-transitory computer storage medium having stored thereon program code executable by a processor, the program code embodying a method comprising:
receiving, by a first virtual machine (VM) that provides a management function for a plurality of VMs, an indication of a pending configuration change;
identifying, by the first VM, from within the plurality of VMs, a VM having a property associated with the first VM;
based on at least identifying the VM having the property, determining, by the first VM, that the first VM comprises the identified VM; and
based on at least determining that the first VM comprises the identified VM, performing, by the first VM, the configuration change on the first VM.

16. The computer storage medium of claim 15, wherein the program code further comprises:
generating the property for the first VM, wherein the property does not comprise an address or a name of the first VM; and
associating the property with the first VM.

17. The computer storage medium of claim 15, wherein performing the configuration change comprises changing at least one VM configuration factor selected from the list consisting of:
memory amount, storage size, processor count, a drive, and a network adapter.

18. The computer storage medium of claim 17, wherein performing the configuration change comprises increasing memory amount, storage amount, processor count, drives, or network adapters.

19. The computer storage medium of claim 15, wherein performing the configuration change comprises performing the configuration change based at least on receiving the indication of the pending configuration change by the first VM and without receiving user login credentials by the first VM.

20. The computer storage medium of claim 15, wherein the property comprises a file property, other than a file name, of a file comprising the first VM, and wherein the property comprises a multi-character random sequence.
